(19) United States
(12) Patent Application Publication
(10) Pub. No.: US 2008/0279262 A1
(43) Pub. Date: Nov. 13, 2008

(54) ON CHIP TRANSMIT/RECEIVE SELECTION

(75) Inventor: Payman Hosseinzadeh Shanjani, San Diego, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/745,420

(22) Filed: May 7, 2007

(51) Int. Cl. H04B 1/38

(52) U.S. Cl. 375/219

(57) ABSTRACT

An integrated circuit radio transceiver and method therefor includes transmit-receive selection circuitry that in a transmit mode, enables a circuit path between an output stage amplifier and an output node or antenna and disables a circuit path between an input amplifier and the output node or antenna. Alternatively, in a receive mode, the circuitry disables the transmit circuit path and enables the second circuit path. The transmit circuit path including transmit front end circuitry, the receive circuit path including receive front end circuitry and all circuitry for enabling and disabling are all on the same integrated circuit as the first and second circuit paths. The specific topologies avoid exceeding breakdown voltages of on-chip transistors used for transmit-receive circuitry operation.

### BACKGROUND

1. Technical Field

The present invention relates to wireless communications and, more particularly, to circuitry for wireless communications.

2. Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of a plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network (PSTN), via the Internet, and/or via some other wide area network.

Each wireless communication device includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier stage. The data modulation stage converts raw data into baseband signals in accordance with the particular wireless communication standard. The one or more intermediate frequency stages mix the baseband signals with one or more local oscillations to produce RF signals. The power amplifier stage amplifies the RF signals prior to transmission via an antenna.

Typically, the data modulation stage is implemented on a baseband processor chip, while the intermediate frequency (IF) stages and power amplifier stage are implemented on a separate radio processor chip. Historically, radio integrated circuits have been designed using bi-polar circuitry, allowing for large signal swings and linear transmitter component behavior. Therefore, many legacy baseband processors employ analog interfaces that communicate analog signals to and from the radio processor.

Prior art radio transceiver systems have typically included a number of separate circuits that jointly operate as a radio. For example, a baseband processor, a radio front end, a power amplifier and a transmit-receive switch have all been made as separate and discrete devices. As the trend towards miniaturization of electronics continues, however, it is desirable to determine an approach to consolidate such transceiver elements into a single integrated circuit. The reason this has not occurred in the past, however, relates to power and or voltage requirements for the specific transceiver elements. For example, a typical integrated circuit element has a low breakdown voltage. Typical designs for some of these transceiver elements, however, require that specific components be able to withstand higher breakdown voltages than a typical device in an integrated circuit is able to withstand. As such, it is desirable to develop designs for such transceiver elements that satisfy operational requirements but that may also be implemented on-chip with other integrated circuit components.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a schematic block diagram illustrating a wireless communication device that includes a host device and an associated radio;

FIGS. 2 and 3 are schematic block diagrams illustrating a wireless communication host device and an associated radio according to two embodiments of the invention;

FIG. 4 is a functional block diagram of an integrated circuit radio transceiver according to one embodiment of the invention that includes transmit-receive selection circuitry;

FIG. 5 is a functional schematic diagram of an integrated circuit radio transceiver according to one embodiment of the invention;

FIGS. 6 and 7 are functional schematic diagrams that illustrate resulting topologies for transmit and receive modes of operation based upon switch positions as driven by the transmit-receive logic according to one embodiment of the invention; and

FIGS. 8 and 9 illustrate a method for selecting between outgoing and in-going radio frequency signals between an antenna and transmit and receive path circuitry, respectively, according to one embodiment of the invention.

### DETAILED DESCRIPTION OF THE DRAWINGS

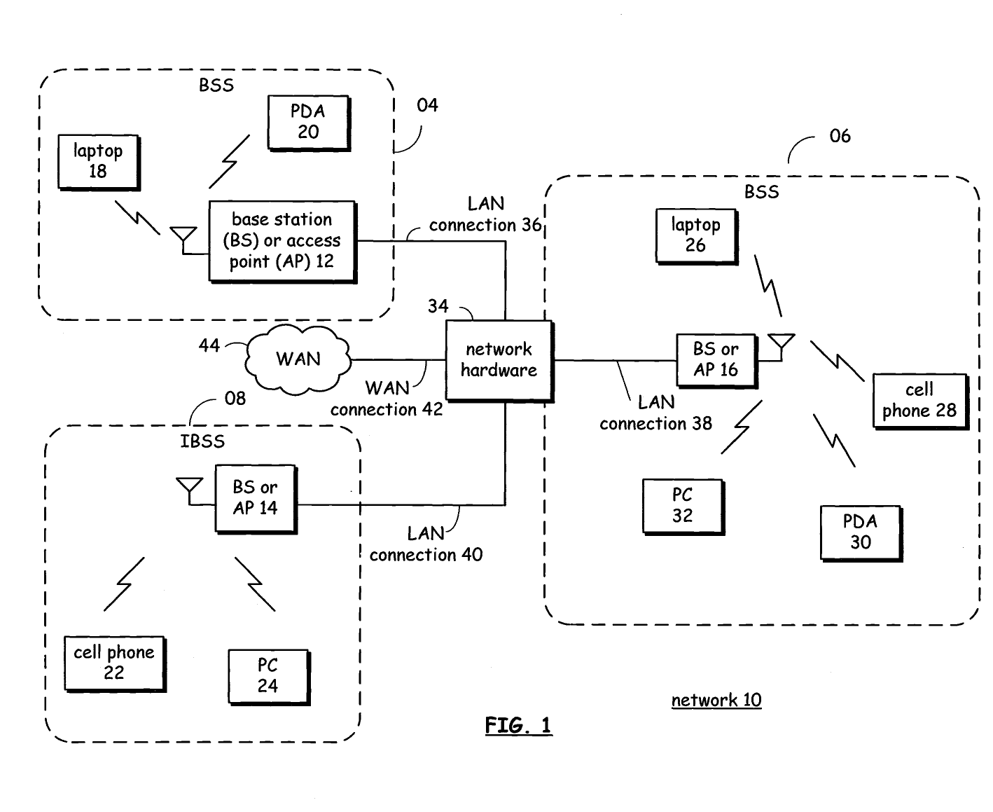

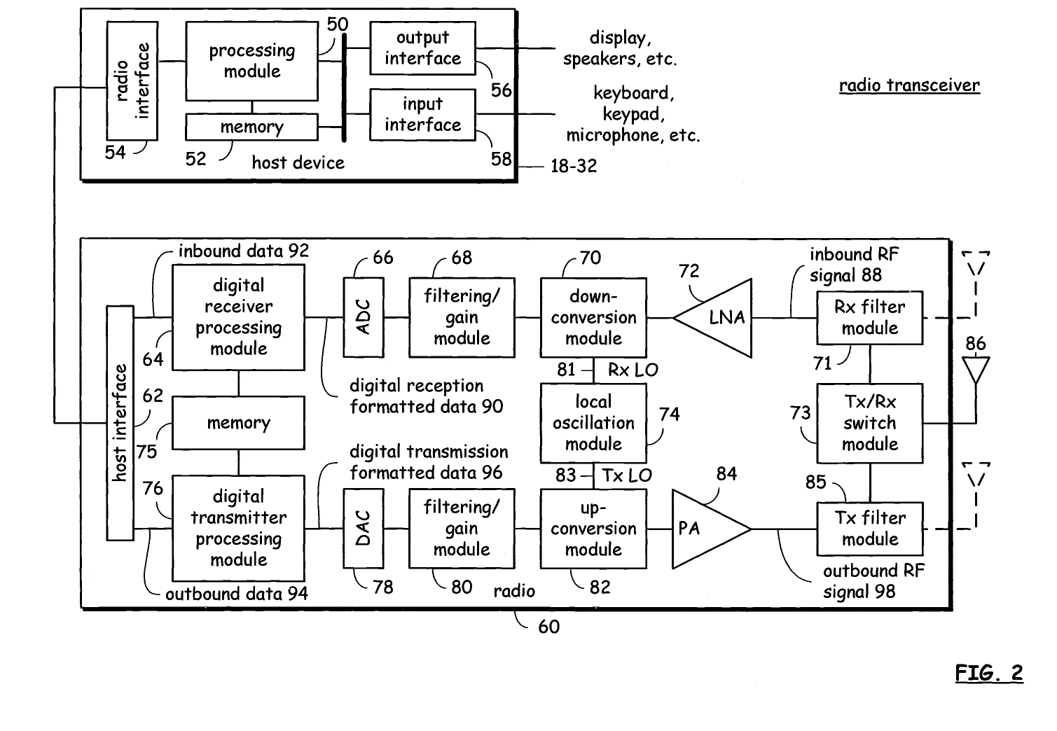

FIG. 1 is a functional block diagram illustrating a communication system that includes circuit devices and network elements and operation thereof according to one embodiment of the invention. More specifically, a plurality of network service areas 04, 06 and 08 are a part of a network 10. Network 10 includes a plurality of base stations or access points (APs) 12-16, a plurality of wireless communication devices 18-32 and a network hardware component 34. The wireless communication devices 18-32 may be laptop computers 18 and 26, personal digital assistants 20 and 30, personal computers 24 and 32 and/or cellular telephones 22 and 28. The details of the wireless communication devices will be described in greater detail with reference to FIGS. 2-9.

The base stations or APs 12-16 are operably coupled to the network hardware component 34 via local area network (LAN) connections 36, 38 and 40. The network hardware component 34, which may be a router, switch, bridge, modem, system controller, etc., provides a wide area network (WAN) connection 42 for the communication system 10 to an external network element such as WAN 44. Each of the base stations or access points 12-16 has an associated antenna or antenna array to communicate with the wireless communication devices in its area. Typically, the wireless communication devices 18-32 register with the particular base station or access points 12-16 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio.

FIG. 2 is a schematic block diagram illustrating a wireless communication host device 18-32 and an associated radio 60. For cellular telephone hosts, radio 60 is a built-in component. For personal digital assistants hosts, laptop hosts, and/or personal computer hosts, the radio 60 may be built-in or an externally coupled component.

As illustrated, wireless communication host device 18-32 includes a processing module 50, a memory 52, a radio interface 54, an input interface 58 and an output interface 56. Processing module 50 and memory 52 execute the corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For data received from radio 60 (e.g., inbound data), radio interface 54 provides the data to processing module 50 for further processing and/or routing to output interface 56. Output interface 56 provides connectivity to an output device such as a display, monitor, speakers, etc., such that the received data may be displayed. Radio interface 54 also provides data from processing module 50 to radio 60. Processing module 50 may receive the outbound data from an input device such as a keyboard, keypad, microphone, etc., via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (Tx/Rx) switch module 73, a local oscillation module 74, a memory 75, a digital transmitter processing module 76, a digital-to-analog converter 78, a filtering/gain module 80, an up-conversion module 82, a power amplifier 84, a transmitter filter module 85, and an antenna 86 operatively coupled as shown. The antenna 86 is shared by the transmit and receive paths as regulated by the Tx/Rx switch module 73. The antenna implementation will depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and modulation. Digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when digital receiver processing module 64 and/or digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and digital receiver processing module 64 and/or digital transmitter processing module 76 executes, operational instructions corresponding to at least some of the functions illustrated herein.

In operation, radio 60 receives outbound data 94 from wireless communication host device 18-32 via host interface 62. Host interface 62 routes outbound data 94 to digital transmitter processing module 76, which processes outbound data 94 in accordance with a particular wireless communication standard or protocol (e.g., IEEE 802.11(a), IEEE 802.11b, Bluetooth, etc.) to produce digital transmission formatted data 96. Digital transmission formatted data 96 will be a digital baseband signal or a digital low IF signal, where the low IF typically will be in the frequency range of one hundred kilohertz to a few megahertz.

Digital-to-analog converter 78 converts digital transmission formatted data 96 from the digital domain to the analog domain. Filtering/gain module 80 filters and/or adjusts the gain of the analog baseband signal prior to providing it to up-conversion module 82. Up-conversion module 82 directly converts the analog baseband signal, or low IF signal, into an RF signal based on a transmitter local oscillation 83 provided by local oscillation module 74. Power amplifier 84 amplifies the RF signal to produce an outbound RF signal 98, which is filtered by transmitter filter module 85. The antenna 86 transmits outbound RF signal 98 to a targeted device such as a base station, an access point and/or another wireless communication device.

Radio 60 also receives an inbound RF signal 88 via antenna 86, which was transmitted by a base station, an access point, or another wireless communication device. The antenna 86 provides inbound RF signal 88 to receiver filter module 71 via Tx/Rx switch module 73, where Rx filter module 71 bandpass filters inbound RF signal 88. The Rx filter module 71 provides the filtered RF signal to low noise amplifier 72, which amplifies inbound RF signal 88 to produce an amplified inbound RF signal. Low noise amplifier 72 provides the amplified inbound RF signal to down-conversion module 70, which directly converts the amplified inbound RF signal into an inbound low IF signal or baseband signal based on a receiver local oscillation 81 provided by local oscillation module 74. Down-conversion module 70 provides the inbound low IF signal or baseband signal to filtering/gain module 68. Filtering/gain module 68 may be implemented in accordance with the teachings of the present invention to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to the wireless communication host device 18-32 via radio interface 54.

As one of average skill in the art will appreciate, the wireless communication device of FIG. 2 may be implemented using one or more integrated circuits. For example, the host device may be implemented on a first integrated circuit, while digital receiver processing module 64, digital transmitter processing module 76 and memory 75 may be implemented on a second integrated circuit, and the remaining components of radio 60, less antenna 86, may be implemented on a third integrated circuit. As an alternate example, radio 60 may be implemented on a single integrated circuit. As yet another example, processing module 50 of the host device and digital receiver processing module 64 and digital transmitter processing module 76 may be a common processing device implemented on a single integrated circuit.

Memory 52 and memory 75 may be implemented on a single integrated circuit and/or on the same integrated circuit as the common processing modules of processing module 50, digital receiver processing module 64, and digital transmitter processing module 76. As will be described, it is important that accurate oscillation signals are provided to mixers and conversion modules. A source of oscillation error is noise coupled into oscillation circuitry through integrated circuitry biasing circuitry. One embodiment of the present invention reduces the noise by providing a selectable pole low pass filter in current mirror devices formed within the one or more integrated circuits.

Local oscillation module 74 includes circuitry for adjusting an output frequency of a local oscillation signal provided therefrom. Local oscillation module 74 receives a frequency correction input that it uses to adjust an output local oscillation signal to produce a frequency corrected local oscillation signal output. While local oscillation module 74, up-conversion module 82 and down-conversion module 70 are implemented to perform direct conversion between baseband and RF, it is understood that the principles herein may also be applied readily to systems that implement an intermediate frequency conversion step at a low intermediate frequency.

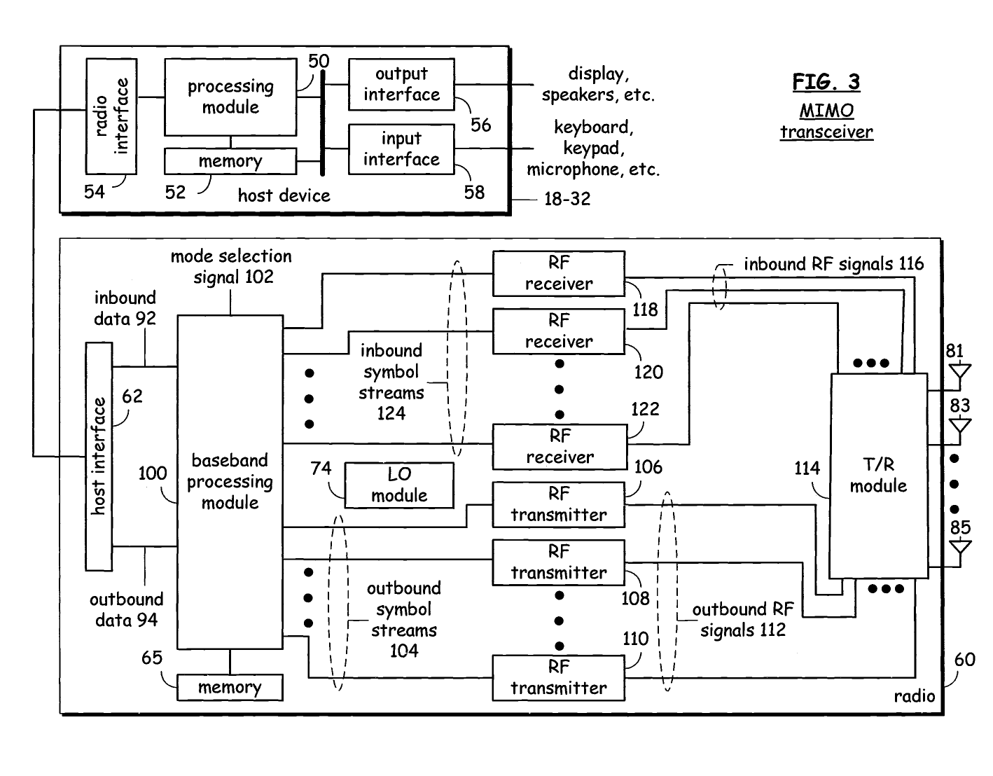

FIG. 3 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, etc., such that the received data may be displayed. The radio interface 54 also provides data from the processing module 50 to the radio 60. The processing module 50 may receive the outbound data from an input device such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a baseband processing module 100, memory 65, a plurality of radio frequency (RF) transmitters 106-110, a transmit/receive (T/R) module 114, a plurality of antennas 81-85, a plurality of RF receivers 118-120, and a local oscillation module 74. The baseband processing module 100, in combination with operational instructions stored in memory 65, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion. The baseband processing module 100 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 65 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The baseband processing module 100 receives the outbound data 94 and, based on a mode selection signal 102, produces one or more outbound symbol streams 104. The mode selection signal 102 will indicate a particular mode of operation that is compliant with one or more specific modes of the various IEEE 802.11 standards. For example, the mode selection signal 102 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. The mode selection signal 102 may also include a code rate, a number of coded bits per subcarrier (NBPSC), coded bits per OFDM symbol (NCBPS), and/or data bits per OFDM symbol (NDBPS). The mode selection signal 102 may also indicate a particular channelization for the corresponding mode that provides a channel number and corresponding center frequency. The mode selection signal 102 may further indicate a power spectral density mask value and a number of antennas to be initially used for a MIMO communication.

The baseband processing module 100, based on the mode selection signal 102 produces one or more outbound symbol streams 104 from the outbound data 94. For example, if the mode selection signal 102 indicates that a single transmit antenna is being utilized for the particular mode that has been selected, the baseband processing module 100 will produce a single outbound symbol stream 104. Alternatively, if the mode selection signal 102 indicates 2, 3 or 4 antennas, the baseband processing module 100 will produce 2, 3 or 4 outbound symbol streams 104 from the outbound data 94.

Depending on the number of outbound symbol streams 104 produced by the baseband processing module 100, a corresponding number of the RF transmitters 106-110 will be enabled to convert the outbound symbol streams 104 into outbound RF signals 112. In general, each of the RF transmitters 106-110 includes a digital filter and upsampling module, a digital-to-analog conversion module, an analog filter module, a frequency up conversion module, a power amplifier, and a radio frequency bandpass filter. The RF transmitters 106-110 provide the outbound RF signals 112 to the transmit/receive module 114, which provides each outbound RF signal to a corresponding antenna 81-85.

When the radio 60 is in the receive mode, the transmit/receive module 114 receives one or more inbound RF signals 116 via the antennas 81-85 and provides them to one or more RF receivers 118-122. The RF receiver 118-122 converts the inbound RF signals 116 into a corresponding number of inbound symbol streams 124. The number of inbound symbol streams 124 will correspond to the particular mode in which the data was received. The baseband processing module 100 converts the inbound symbol streams 124 into inbound data 92, which is provided to the host device 18-32 via the host interface 62.

As one of average skill in the art will appreciate, the wireless communication device of FIG. 3 may be implemented using one or more integrated circuits. For example, the host device may be implemented on a first integrated circuit, the baseband processing module 100 and memory 65 may be implemented on a second integrated circuit, and the remaining components of the radio 60, less the antennas 81-85, may be implemented on a third integrated circuit. As an alternate example, the radio 60 may be implemented on a single integrated circuit. As yet another example, the processing module 50 of the host device and the baseband processing module 100 may be a common processing device implemented on a single integrated circuit. Further, the memory 52 and memory 65 may be implemented on a single integrated circuit and/or on the same integrated circuit as the common processing modules of processing module 50 and the baseband processing module 100.

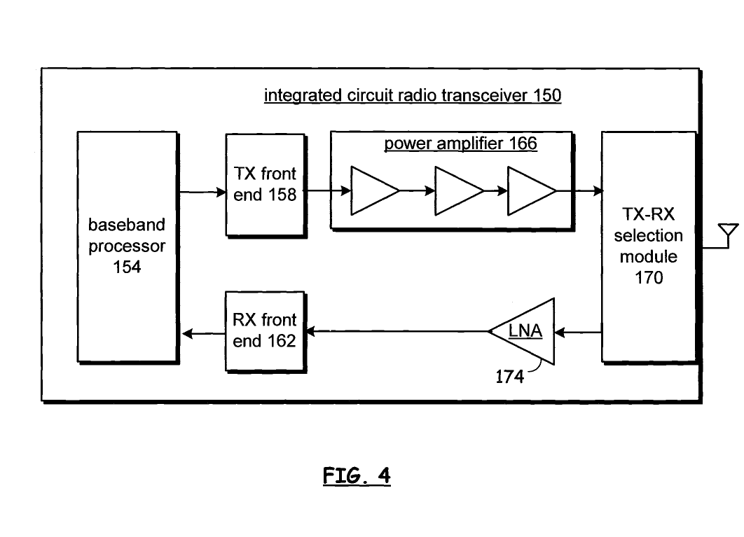

FIG. 4 is a functional block diagram of an integrated circuit radio transceiver according to one embodiment of the invention that includes transmit-receive selection circuitry. The integrated circuit radio transceiver 150 includes a baseband processor 154 that is operable to generate outgoing digital signals and to receive and process ingoing digital signals. The outgoing digital signals are produced to transmit front end 158 and are received from receive front end 162. Transmit front end 158 is operably disposed to receive the outgoing digital signals from the baseband processor, to convert the outgoing digital signals to an analog or continuous waveform, and amplify and upconvert the continuous waveform signals to radio frequency. The outgoing radio frequency (RF) signals are produced by transmit front end 158 to power amplifier 166 which is operable to increase the transmission power a desired amount. Power amplifier 166 is operably disposed to produce amplified outgoing RF signals to transmit-receive selection module 170. Transmit-receive selection module 170 is operable to selectively radiate outgoing RF signals from a coupled antenna or, alternatively, to selectively produce ingoing RF signals received at the coupled antenna to low noise amplifier 174.

Transmit-receive selection module 170 includes logic to enable power amplifier 166 to produce the amplified outgoing RF to the antenna and to disable a communication path between the antenna and low noise amplifier 174 or, alternatively, to disable power amplifier 166 from producing the amplified outgoing RF signal to the antenna and to enable communications from the antenna to the low noise amplifier 174. One aspect of one embodiment of integrated circuit radio transceiver 150 is that both the power amplifier 166 and the transmit-receive selection module 170 are both formed on the same integrated circuit as the transmit and receive radio front end circuitry. Transmit-receive selection module 170 comprises a low breakdown switch that disables an output stage of power amplifier 166 as well as configurable filter circuitry that, based upon mode, is operable to impedance match and to create very high impedance circuit paths for both transmit and receive circuit paths according to the transceiver is in a transmit or a receive mode of operation.

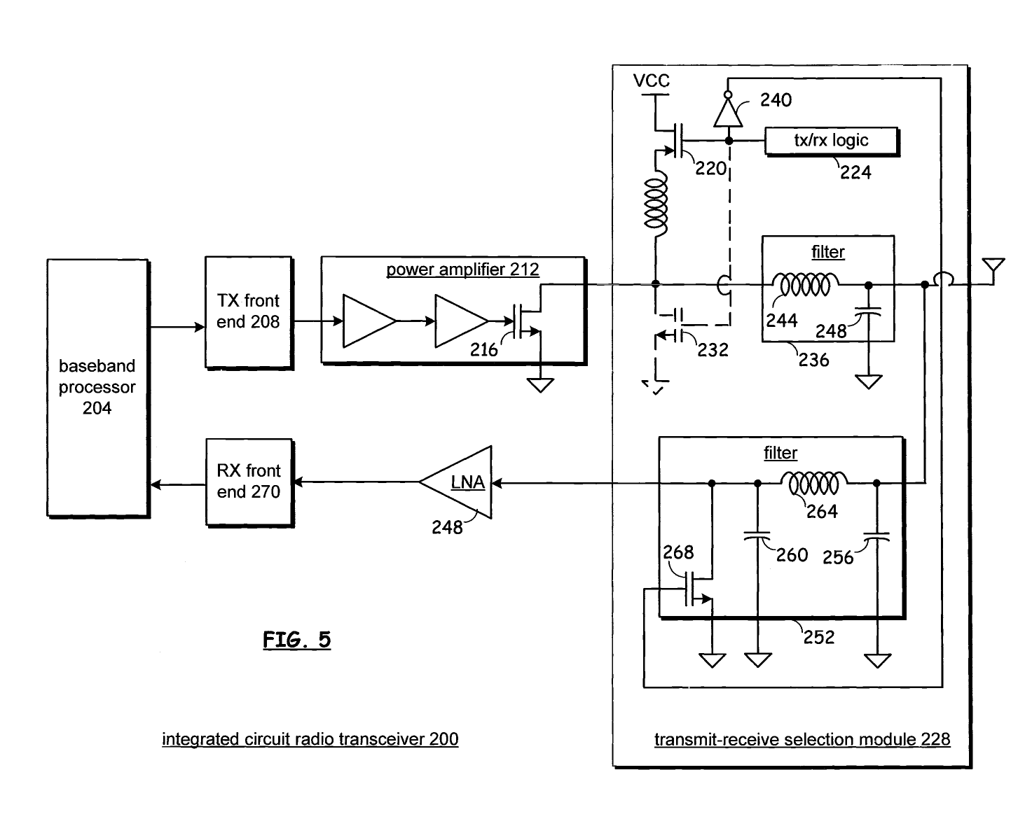

FIG. 5 is a functional schematic diagram of an integrated circuit radio transceiver according to one embodiment of the invention. Integrated circuit radio transceiver 200 includes baseband processor 204 that produces outgoing digital signals to transmit front end 208 which in turn produces outgoing RF to power amplifier 212. Power amplifier 212 is a three stage amplifier module in the described embodiment that includes a MOSFET 216 operable as a current driver for the output stage. MOSFET 216 includes a source coupled to circuit common (or ground) and a drain that is operably coupled to a source of a P-type MOSFET 220 that is operable as a switch. MOSFET 220 is a low breakdown switch that operably disables the output stage transistor of power amplifier 212. With the illustrated configuration and similar configurations, MOSFET 220 does not experience voltage swings that will exceed the low breakdown voltage of the device and thus may be formed on-chip with the radio front end circuitry. Thus, the design avoids the traditional need for large switching devices that are typically off chip. Further, in one embodiment of the invention, a bipolar junction transistor is used in place of MOSFET 216.

A drain of MOSFET 220 is coupled to a supply while the gate is coupled to logic 224 for controlling operation of the transmit selection circuitry of transmit-receive selection module 228. Logic 224 is operable to generate a biasing signal to the gate of MOSFET 220 to enable MOSFET 220 to operably open a connection between its drain and source terminals to disable the drain of MOSFET 216 to be operably disposed to the supply. As is further shown, an inductive element operable as a choke is disposed between MOSFETs 216 and 220. While the described embodiment utilizes a P-type MOSFET device for switch 220 and N-type MOSFET devices for the remaining MOSFETs of FIG. 5, it should be understood that the disclosed embodiments may also be implemented utilizing P-type MOSFET devices in place of N-type MOSFET devices and vice-versa with corresponding changes to the circuitry to provide appropriate logic for the desired operation.

When MOSFET 220 is off, MOSFET 216 is rendered inoperable even if a proper bias voltage is presented to the gate of MOSFET 216. Thus, MOSFET 216 may be kept in an operational mode in terms of its quiescent point biasing to eliminate settle time when the transceiver transitions from a receive mode to a transmit mode. Thus, logic 224 is operable to control the output of power amplifier 212 in a way that does not require significant settle time. Additionally, because MOSFET 216 (or alternative a bipolar junction transistor used as a current driver) has a very small effective resistance when biased on, the input node of the transistor is effectively coupled to its output node which therefore couples the input node to circuit common. Here, the source and drain terminals of MOSFET 216 are effectively coupled to each other and to circuit common. Moreover, because the drain of MOSFET 216 is effectively coupled to circuit common, the inductive element 244 is also effectively coupled to circuit common to transform filter 236 into a resonant circuit having very high impedance. Thus, no additional switch is needed to disable signals from flowing from the antenna to power amplifier 212 during a receive mode of operation.

As may further be seen, transmit-receive selection module 228 also includes optional circuitry to control operation of an optional MOSFET 232 having a drain coupled to the output of current driver MOSFET 216 and a source coupled to circuit common. As may be seen, in the embodiment shown, MOSFET 232 is operably disposed to receive a gate control signal of the same logic state as MOSFET 216. The reason for this is that MOSFET 232 is an N-type device while MOSFET 220 is a P-type device. Thus, the two devices turn on with opposite logic states of a control signal applied to the gate terminal. As such, operation of MOSFETs 220 and 232 is mutually exclusive. Thus, when MOSFET 216 is enabled because MOSFET 220 is biased in an on state, MOSFET 232 is off and the output node of MOSFET 216 is operably coupled to the antenna by way of a filter 236. Other known ways may be utilized for implementing such logic and will be based in part upon the type of devices being utilized (P-type or N-type).

Filter 236 comprises inductive element 244 and a capacitive element 248 configured to pass signals having a specified frequency of interest produced by power amplifier 212 and to operably impedance match the output of amplifier 212 with the load of the antenna. For the frequency of interest, filter 236 operably lowers the impedance seen by the output of power amplifier 212 to enable power amplifier 212 to generate greater output current and therefore greater output power. With MOSFET 232 in an off state (if included in the application), inductive element 244 is coupled in series between the drain of current driver MOSFET 216 and the antenna. When transmit-receive logic 224 generates an output signal to turn off MOSFET 220 to disable the output stage of power amplifier 212 (namely to turn off MOSFET 216 in the described embodiment), MOSFET 232 is turned on to operably couple inductive element 244 to circuit common. As stated before, however, inductive element 244 is effectively coupled to circuit common even without a MOSFET 232 when MOSFET 220 is turned off by logic 224 as long as MOSFET 216 is biased in an on state while MOSFET 220 is off since the effective resistance of MOSFET 216 is very low while in an operational state. Including MOSFET 232 merely improves circuit operation but is not required.

The values of inductive element 244 and 248 are selected to resonate when coupled in parallel whenever inductive element 244 is coupled to circuit common and in parallel to capacitive element 248 (which is also connected to circuit common). As such, when the source and drain of MOSFET 216 are coupled to ground when MOSFET 216 is disabled, no signal flows from power amplifier 212 to the antenna. From the perspective of the antenna, the parallel combination of inductive element 244 and capacitive element 248 creates a very high impedance that operably steers any signal at the antenna away from filter 236 towards filter 252.

Filter 252 comprises capacitive elements 256 and 260 and inductive element 264 configured in a Pi-Mesh network configuration as shown. As may further be seen, a MOSFET 268 is operably coupled as a switch across capacitive element 260 and, when on, shorts capacitive element 260 and couple inductive element 264 to circuit common. As may further be seen, MOSFETs 220 and 268 are biased into an operational state on opposite logic signals. MOSFET 220 is driven directly by transmit-receive logic 224 while MOSFET 268 is driven by the opposite of the logic signal produced by transmit-receive logic 224 as produced by inverter 240. The output of inverter 240 is based upon but opposite of the logic signal produced by transmit-receive logic 224.

Thus, when switch 220 is on during a transmit mode of operation, the output of power amplifier 212 is operably coupled to the antenna while the input the LNA (of the receive path) is grounded. Further, in this mode, the Pi-Mesh network becomes a resonant filter providing very high impedance to any signal at the antenna. As such, any signal produced by power amplifier 212 is radiated and is not conducted to circuit common or to LNA 248. Conversely, when MOSFETs 220 and 268 are off based upon the logic state of the signal produced by transmit-receive logic 224, MOSFET 268 is biased off, filter 252 resumes a Pi-Mesh network topology and signals received at the antenna are conducted to LNA 248. LNA 248 then produces an amplified ingoing RF signal to RX front end 270 for down-conversion to one of baseband or an intermediate frequency, for amplification and filtering and for conversion to a digital form for processing by baseband processor 204.

One aspect of the embodiment of FIG. 5 is that control for transmit and receive operations is based upon on-chip transistors made with routine low breakdown voltage characteristics. In contrast to prior art designs for transmit-receive switches which are off chip because of required high breakdown voltage capabilities, the present approach allows for an integrated design within an integrated circuit to support single chip designs and applications for radio transceivers.

It should be noted that quarter wavelength transmission lines are often used for impedance matching and thus may be used, for example, in place of filter 236. Further, strip lines and/or micro-strip filters that effectively produce the circuitry of filter 252 may be made in place of actual devices configured as shown in FIG. 5. As such, for example, a switch 268 may be used to create a short from one end of a strip line to circuit common to achieve the described operation with the devices shown in FIG. 5. The strip line length, width, thickness and substrate permeability may all be varied in design to achieve the desired filter response represented by the circuitry of filter 252. In the described embodiment, however, actual devices are used to create the illustrated circuitry in order to reduce IC real estate. Alternate embodiments, however, include all types of implementations that achieve the described functionality.

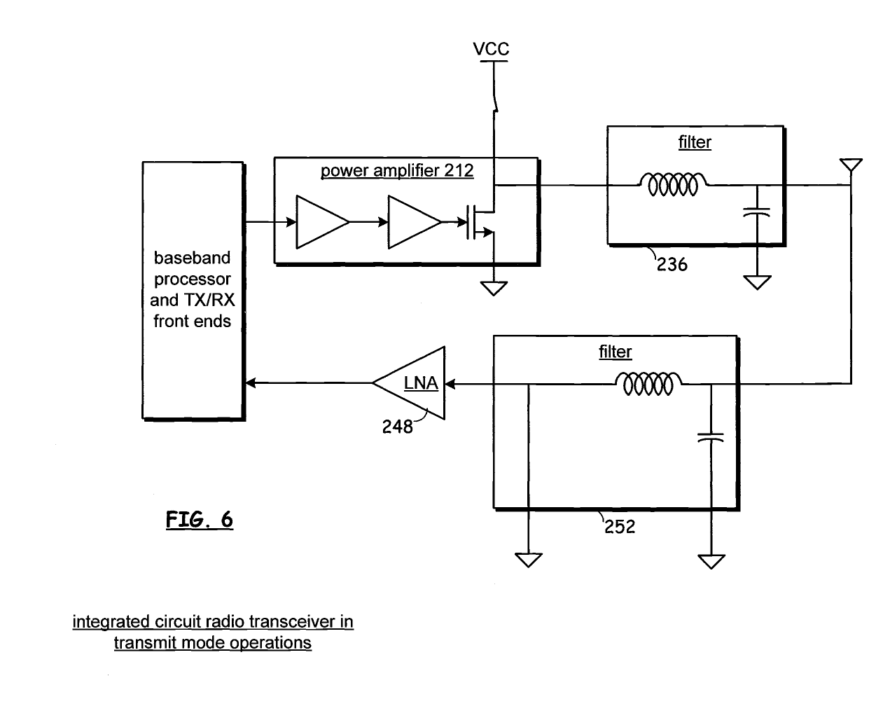

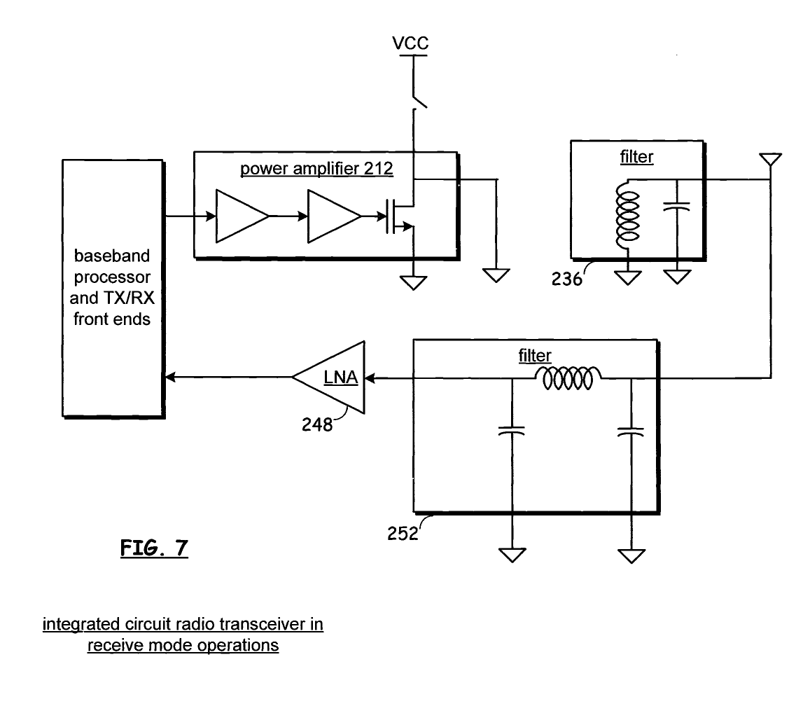

FIGS. 6 and 7 are functional schematic diagrams that illustrate resulting topologies for transmit and receive modes of operation based upon switch positions as driven by the transmit-receive logic of FIG. 5 according to one embodiment of the invention. FIGS. 6 and 7 are primarily intended to clarify operation of the embodiment of FIG. 5. In a transmit mode of operation when switches 220 and 268 are closed while switch 232 is open, an effective topology is illustrated in FIG. 6. More specifically, the power amplifier 212 produces an amplified output to the antenna by way of filter 236 wherein filter 236 impedance matches the impedance of the load (antenna, e.g., 50 ohms) to the output impedance of power amplifier 212. At the same, filter 252 is reconfigured from a Pi-Mesh network to a parallel LC filter that resonates to produce a very high impedance for any signal at the antenna (e.g., the output signal produced by power amplifier 212). As such, the output of amplifier 212 is radiated from the antenna and is not conducted to LNA 248.

In contrast to FIG. 6, FIG. 7 illustrates the receive mode of operation. Here, an open is created between the supply VCC and the current driver output amplifier of power amplifier 212 effectively disabling the amplifier. Further, the output of the amplifier 212 is grounded or coupled to circuit common. Further, filter 236 is reconfigured to place the inductive and capacitive elements in parallel to resonate and to create a very high impedance from the perspective of a signal at the antenna. Conversely, filter 252 is configured into the Pi-Mesh network which provides very low impedance at a frequency band of interest for ingoing RF signals to allow such signals to pass to LNA 248.

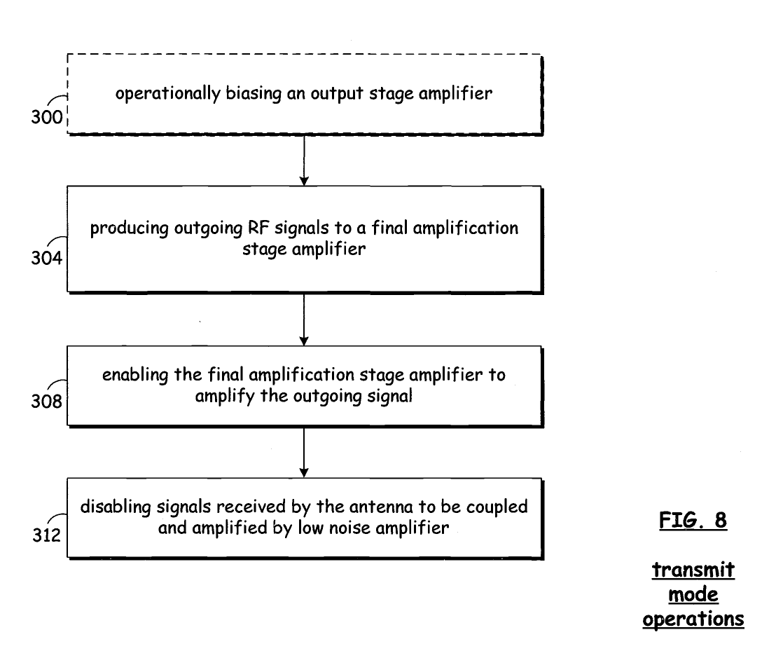

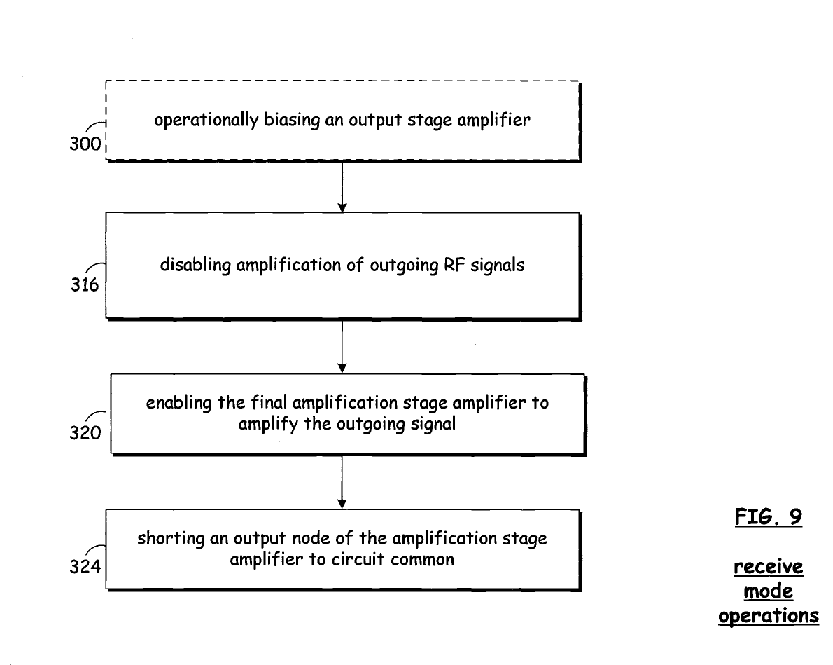

FIGS. 8 and 9 illustrate a method for selecting between outgoing and in-going radio frequency signals between an antenna and transmit and receive path circuitry, respectively, according to one embodiment of the invention. Generally, the method allows, but does not require, operationally biasing an output stage amplifier for amplifying outgoing radio frequency signals and a low noise amplifier for amplifying in going radio frequency signals wherein both amplifiers are formed on the same integrated circuit with radio transceiver circuitry (step 300). Generally, during an operational mode, it is desirable to maintain the output and input amplifiers in a biased state to reduce settle time for fast signal processing. Stated differently, especially with respect to the output stage power amplifier, such devices are not required to be turned off to avoid a breakdown voltage of a controlling on-chip transistor operating as a switch for transmit-receive selection operations.

Thereafter, in a transmit mode of operation as is illustrated in FIG. 8, the method includes producing outgoing RF signals to a final amplification stage amplifier (step 304) and enabling the final amplification stage amplifier to amplify the outgoing signal (step 308). At the same time, the method includes disabling signals received by the antenna to be coupled and amplified by low noise amplifier (step 312). In a receive mode of operation as is illustrated in FIG. 9, the method includes disabling amplification of outgoing RF signals (step 316), enabling the low noise amplifier the receive signals from the antenna (step 320) and shorting an output node of the amplification stage amplifier to circuit common (step 324). As may be seen in relation to FIG. 9, optional step 300 is included to demonstrate that the output stage amplifier may be operably biased even during receive mode operations.

In more general terms, the method of FIGS. 8 and 9 include creating a first filter response to operably couple the output node of the amplification stage amplifier to the antenna and to impedance match the output node to the antenna impedance during the transmit mode of operation. This first filter response may be, for example, setting switch positions to produce the topology relating to filter 236 of FIG. 6 which supports transmission of outgoing RF signals. In a transmit mode, the method also generally includes creating a second filter response to operably isolate the input of the low noise amplifier to the antenna during the transmit mode of operation as shown by the topology of filter 252 in relation to LNA 248.

The method also generally includes creating a third filter response to operably isolate the output node of the amplification stage amplifier from the antenna during the receive mode of operation as demonstrated by the topology of FIG. 7, especially relating to filter 236. Further, the method generally includes creating a fourth filter response to operably couple the input of the low noise amplifier to the antenna during the receive mode of operation as shown in relation to the Pi-Mesh network topology of filter 252.

The discussion of the preceding Figures of the present specification generally teach an approach for using an on-chip switch with low voltage break down characteristics to control signal flow during transmit and receive operations. Generally, each switch used to control transmit or select operations is configured in a circuit path which does not expose the device to voltage swings that exceed its breakdown voltage. For example, signal swings are limited to the value of the supply voltage source. In more traditional approaches, single pole double throw type approach is implemented in which peak-to-peak signal ranges exceed the capacity of an on-chip transistor operating as a switch. Accordingly, the switching circuitry is utilized in an off-chip circuit. One specific technique includes using an on-board switch to selectively enable or disable an output stage amplifier. Another technique includes changing filter topologies that in one mode allow signal pass through and in another mode block signal pass through. Here especially, alternate approaches that achieve the same result may be utilized. In a general sense, however, circuit topologies are used to steer current towards an antenna in a transmit mode and away from receive path circuitry. In a receive mode, current is steered away from transmit path circuitry and towards receive path circuitry.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. An integrated circuit radio transceiver, comprising:
a baseband processor for processing ingoing and outgoing digital communication signals;
an antenna for radiating outgoing RF signals and for receiving ingoing RF signals;
a transmitter front end for generating the outgoing RF signals based upon the outgoing digital communication signals;
a power amplifier operably disposed to receive the outgoing RF signals from the transmitter front end to produce amplified outgoing RF signals;
a receiver front end for generating the ingoing digital communication signals based upon ingoing RF signals;
a low noise amplifier operable to couple the ingoing RF signals to the receiver front end; and
an onboard transmit-receive selection module disposed to operably couple the outgoing RF signals to the antenna and to operably couple the ingoing RF signals received by the antenna to the low noise amplifier.

2. The integrated circuit radio transceiver of claim 1 wherein the onboard transmit receive selection module includes switching circuitry operable to disable an output stage of a power amplifier.

3. The integrated circuit radio transceiver of claim 2 wherein the switching circuitry operable to disable the output stage of the power amplifier comprises an on-chip transistor.

4. The integrated circuit radio transceiver of claim 2 further including an inductive element coupled between the switching circuitry and an output node of the output stage of the power amplifier.

5. The integrated circuit radio transceiver of claim 2 wherein the output stage comprises a large current capable on-chip transistor.

6. The integrated circuit radio transceiver of claim 5 wherein the large current capable on chip transistor comprises a first MOSFET device and wherein the switching circuitry is operably disposed between a supply voltage and a drain of the MOSFET device.

7. The integrated circuit radio transceiver of claim 6 wherein the switching circuitry comprises a second MOSFET transistor having a low breakdown voltage.

8. The integrated circuit radio transceiver of claim 6 wherein the first MOSFET remains operably biased during receive operations when the first MOSFET is operably disabled by the second MOSFET.

9. The integrated circuit radio transceiver of claim 8 further including logic coupled to a gate of the second MOSFET to selectively and operatively couple the drain of the first MOSFET to the supply voltage during transmit operations.

10. The integrated circuit radio transceiver of claim 8 further including a third MOSFET having a drain operably coupled to an input of the low noise amplifier wherein the logic is coupled to a gate of the third MOSFET to selectively and operatively couple the input of the low noise amplifier to ground during transmit operations.

11. The integrated circuit radio transceiver of claim 10 further including a first filter module operably coupled between an input-output node of the switching circuitry and the input of the low noise amplifier wherein, when the third MOSFET is operably biased to short the low noise amplifier input to circuit common, the first filter module is operable to create a very high impedance to any signal at the input-output node of the switching circuitry and when the third MOSFET is not operably biased, to create a band pass filter for a frequency of interest to allow a signal at the input-output node of the switching circuitry to pass to the input of the LNA.

12. An integrated circuit radio transceiver on chip transmit-receive selection module for operably coupling outgoing RF signals produced onto a transmit path by transmit path circuitry to an antenna during a transmit mode of operation and for operably coupling ingoing RF signals received by the antenna to receive path circuitry on a receive path during a receive mode of operation, the on chip selection module comprising:
first filter circuitry on the transmit path operable to impedance match in a first mode operation and to create a very high impedance at a specified frequency in a second mode of operation; and
second filter circuitry on the receive path operable to impedance match in the second mode operation and to create a very high impedance at a specified frequency in the first mode of operation.

13. The on-chip transmit receive selection module of claim 12 further including switching circuitry operable to disable an output stage of a power amplifier of the transmit path circuitry.

14. The on-chip transmit receive selection module of claim 13 wherein the switching circuitry operable to disable the output stage of the power amplifier comprises an on-chip transistor.

15. The on-chip transmit receive selection module of claim 13 further including an inductive element coupled between the switching circuitry and an output node of the output stage of the power amplifier.

16. The on-chip transmit receive selection module of claim 13 wherein the switching circuitry is operable to enable an operationally biased large current capable on-chip transistor at the output stage of the transmitter circuitry and to operably ground an input of the receiver circuitry during the transmit mode of operation to the antenna.

17. The on-chip transmit receive selection module of claim 13 wherein the switching circuitry is operable to disable an operationally biased large current capable on-chip transistor at the output stage of the transmitter circuitry and to operably couple an input of the receiver circuitry to the antenna during a receive mode of operation.

18. The integrated circuit radio transceiver of claim 17 wherein the switching circuitry comprises a transistor having a low breakdown voltage for enabling and disabling the operationally biased large current capable on-chip transistor at the output stage of the transmitter circuitry.

19. A method for selecting between outgoing and in-going radio frequency signals between an antenna and transmit and receive path circuitry, respectively, the method comprising:
operationally biasing an output stage amplifier for amplifying outgoing radio frequency signals and a low noise amplifier for amplifying in going radio frequency signals wherein both amplifiers are formed on the same integrated circuit with radio transceiver circuitry;
in a transmit mode of operation:
producing outgoing RF signals to a final amplification stage amplifier;
enabling the final amplification stage amplifier to amplify the outgoing signal;
disabling signals received by the antenna to be coupled and amplified by low noise amplifier; and
in a receive mode of operation:
disabling amplification of outgoing RF signals;
enabling the low noise amplifier the receive signals from the antenna; and
shorting an output node of the amplification stage amplifier to circuit common.

20. The method of claim 19 further including creating a first filter response to operably couple the output node of the amplification stage amplifier to the antenna and to impedance match the output node to the antenna impedance during the transmit mode of operation.

21. The method of claim 19 further including creating a second filter response to operably isolate the input of the low noise amplifier to the antenna during the transmit mode of operation.

22. The method of claim 19 further including creating a third filter response to operably isolate the output node of the amplification stage amplifier from the antenna during the receive mode of operation.

23. The method of claim 19 further including creating a fourth filter response to operably couple the input of the low noise amplifier to the antenna during the receive mode of operation.

24. A method for controlling transmit-receive operations, comprising:
in a transmit mode, enabling a first circuit path between an output stage amplifier and an output node or antenna and disabling a second circuit path between an input amplifier and the output node or antenna;
in a receive mode, disabling the first circuit path and enabling the second circuit path; and
wherein the first circuit path is a transmit circuit path that includes a transmitter front end circuitry and the second circuit path is a receive circuit path that includes a receiver front end and further wherein all circuitry for enabling and disabling is on the same integrated circuit as the first and second circuit paths.
